(19) United States
(12) Patent Application Publication
(10) Pub. No.: US 2010/0297297 A1
(43) Pub. Date: Nov. 25, 2010

(54) ENERGY BEVERAGES AND METHODS FOR FABRICATION THEREOF

(75) Inventor: McCarthy Hanger, La Jolla, CA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(73) Assignee: DIABETICA RESEARCH SOLUTIONS, INC., Boca Raton, FL (US)

(21) Appl. No.: 12/767,776

(22) Filed: Apr. 26, 2010

Related U.S. Application Data
(60) Provisional application No. 61/172,699, filed on Apr. 24, 2009.

(51) Int. Cl. A23L 1/303; A23L 1/302

(52) U.S. Cl. 426/73; 426/72

(57) ABSTRACT

Powder composition for preparing an energy beverage are provided, the powder compositions including at least one vitamin of group B, chromium picolinate, and calcium carbonate, and optionally also including other vitamins, minerals, or nutrient, such as vitamins A, C, and/or E. The beverage is designed as means of providing additional energy to persons suffering from diabetes. Methods for preparing such a powdered composition and energy beverage are also provided.

### CROSS-REFERENCES TO OTHER RELATED PATENT APPLICATIONS

This application claims the benefit of U.S. Provisional Application Ser. No. 61/172,699 filed Apr. 24, 2009 which is incorporated herein by reference in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### FIELD OF THE INVENTION

The present invention relates generally to energy beverages, and, more specifically, to energy beverages formulated for consumption by persons suffering from diabetes.

### BACKGROUND

One of the major complaints of persons suffering from diabetes is lack of energy. Although there are a few products comprising powdered vitamins, minerals, or nutrients that have been on the market, no prior product has been specifically designed to give diabetics natural, safe and sustained energy. Some of such existing products include caffeine, sugar, or herbal formulas that stimulate the adrenal glands or causes changes to the vaso-dilation system. Having caffeine, sugar, or such stimulating herbal formulas is undesirable due to negative side effects.

In addition, there are no vitamins in effervescent powder form specifically formulated for the diabetics on the market today. Instead, some of such products are in pill form, but many diabetics suffer from gastropuresis, which can be caused by damage to the vagus nerve. Gastropureseis is a digestive disorder that makes simple digestion difficult for the diabetic. In addition, the thought of taking yet another pill is repugnant to many diabetes patients. However, a product in the powdered form suspended in water is very attractive as it is far easier to digest, makes the ingredients more immediately bio-available, and also satisfies the diabetic's need for hydration, which is one of the cornerstones of health as described by endocrinologists and the American Diabetes Association.

No other powdered vitamin products contain chromium picolinate, biotin, and other ingredients described below; nor do the existing products provide the specific ratios of high grade vitamins of the vitamin B family, also described below. Yet, vitamin B deficiency is widespread among diabetic patients. The common symptoms of vitamin B deficiency are an exact correlation to the diabetic's most difficult health issues: poor circulation, poor healing, visual problems, nerve damage, hypertension, peripheral neuropathy, depression, increased risk of heart attack and stroke, and lack of energy.

It is also beneficial to have a product that is designed to be convenient, portable, and taken whenever the person feels they need to increase their energy and hydration. No other vitamin or nutritional supplement in existence is in this form.

In view of the foregoing, it is very desirable to have a product that can remedy all or many of the above-described problems and deficiencies that characterize the existing products. Currently, such a product has not been provided. The present application provides the formulations that achieve these goals and describes the methods of using such compositions.

### SUMMARY

We have discovered that when certain ingredients are combined together in a powdered form, persons suffering from diabetes can be provided a sustained increase in their energy, without using sugar, caffeine, or artificially increasing their blood pressure through vaso-constriction. No other energy drink on the market can be as carefully and confidently taken by a person with diabetes.

The above-stated goal has been achieved by carefully maintaining the ratio of ingredients, and by adding ingredients that have been specifically cited in many clinical studies to provide energy at the cellular level, as well as control blood sugar levels. The invention is a process of not only combining the ingredients in ratios that are safe and effective, but also in the method of delivery. By adding calcium carbonate, the cell walls are opened at a metabolic level and escorting the complex of vitamin B family product(s) and other vitamins and nutrients into the cells, which allows them to become more immediately bio-available.

According to embodiments of the invention, a powder composition is provided, the powder composition comprising a quantity of at least one vitamin selected from the group B vitamins, a quantity of chromium picolinate; and a quantity of calcium carbonate. The powder composition is free of caffeine, sugar and herbal ingredients capable of stimulating the adrenal glands or cause changes to the vaso-dilation system.

According to other embodiments of the invention, a method for providing additional energy to a person suffering from diabetes is disclosed, the method comprising using the powder composition described above, preparing the energy beverage and orally consuming the energy beverage by the person suffering from diabetes.

### DETAILED DESCRIPTION

The following are the definitions of some terms as used in the present application. If the terms and definitions provided below are inconsistent in any way with their generally accepted meanings, then, only to the extent of such potential inconsistencies, the meanings provided below prevail.

The term “a vitamin” refers to an organic compound that is required, in small amounts, for the normal metabolic functioning of the body.

The term “diabetes” refers to a disease or disorder characterized by the inability of a body to produce or properly use insulin causing abnormally high glucose levels in the blood. The term “diabetes” as used herein includes “type 1 diabetes” (failure of the pancreas to release a sufficient amount of insulin) and “adult-onset or type 2 diabetes” (insulin is produced, but in insufficient quantities, and/or the body does not properly utilize insulin that is provided).

The term “vitamin B6” is used interchangeably with the term “pyridoxine” [chemically, (5-hydroxy-6-methyl-3,4-dihydroxymethyl) pyridine] and refers to the compound having the formula B6:

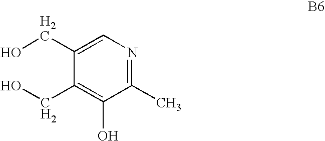

The term “vitamin B5” is used interchangeably with the term “panthotenic acid” [in the IUPAC nomenclature, 3-(2,4-dihydroxy-3,3-dimethylbutanamido)propanoic acid] and refers to the compound having the formula B5:

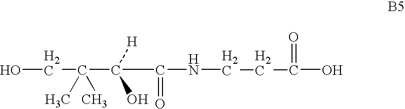

The term “vitamin B1” is used interchangeably with the term “thiamine” [chemically, 3-((4-amino-2-methylpyrimidin-5-yl)methyl)-5-(2-hydroxyethyl)-4-methylthiazol] and refers to the compound having the formula B1:

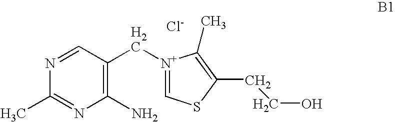

The structure of vitamin B1 is shown above in the hydrochloride form, i.e., as a cation carrying a positive charge on the nitrogen in the thiazole ring, with the chloride counter ion.

The term “vitamin A” refers to the compound having the formula A [chemically, 3,7-dimethyl-9-(2,6,6-trimethylcyclohex-1-enyl)nona-2,4,6,8-tetraen-1-ol]:

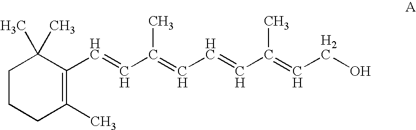

The term “niacinamide,” also known as vitamin B3 or as amide of nicotinic acid (i.e., pyridine-3-yl-formamide) refers to one of the B vitamins, which is the compound having the formula B3:

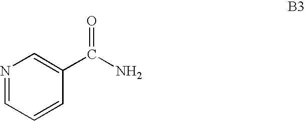

The term “biotin,” also known as vitamin B7 [chemically, 5-((3aS,4S,6aR)-2-oxohexahydro-1H-thieno[3,4-d]imidazol-4-yl)pentanoic acid], refers to another water-soluble B vitamin, which is the compound having the formula B7:

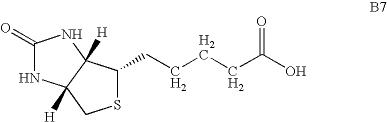

The term “vitamin E” refers to a complex mixture of eight related α-, β-, γ-, and δ-tocopherols and the corresponding four tocotrienols. The formula of one of them, i.e., of α-tocopherol [chemically, (S)-2,5,7,8-tetramethyl-2-((4S,8S)-4,8,12-trimethyltridecyl) chroman-6-ol] is shown below (formula E):

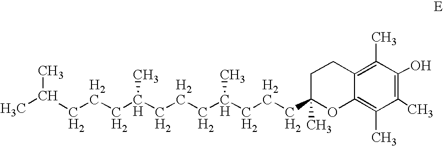

The term “vitamin C” is used interchangeably with the term “ascorbic acid” [i.e., (R)-5-((S)-1,2-dihydroxyethyl)-3,4-dihydroxyfuran-2(5H)-one] and refers to the compound having the formula C:

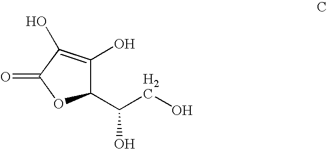

The term “vitamin B9” is used interchangeably with the term “folic acid” [chemically, 2-(4-((2-amino-4-oxo-3,4-dihydropteridin-6-yl)methylamino)benzamido) pentanedioic acid] and refers to the compound having the formula B9 (shown in the keto-form):

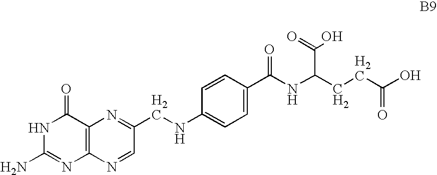

The term “chromium picolinate” refers to a derivative of picolinic acid having the general net formula

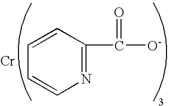

The term calcium carbonate refers to either of two derivatives of carbonic acid having the formulae Ca(CO₃)₂ or CaHCO₃.

The term “size of the particles” refers to the diameter (for the spherical particles) or to the longest linear dimension (for the oval or irregularly shaped particles).

As mentioned above, one of the major complaints of persons suffering from diabetes is fatigue or lack of energy. This lack of energy can be caused by excess sugar in the bloodstream, and dehydration caused by excess urination. A typical approach that has been used is to intervene with a regimen of diet and exercise. However, this approach has often been insufficient due to the cyclical nature of obesity, depression, and overall lack of vigor caused by the gradual effects of diabetes.

According to an embodiment of the present invention, there is provided a powder composition for preparing a beverage for persons suffering from diabetes, the beverage providing additional energy to the patient. The powder composition includes a vitamin of the group B vitamins or a mixture of several group B vitamins, chromium picolinate, and calcium carbonate. According to embodiments of the present invention, the powder compositions are free of caffeine and free of sugar and contain no herbal ingredients that may stimulate the adrenal glands or cause changes to the vaso-dilation system.

Any one of vitamins B1, B5, B6, biotin, niacinamide, and/or B9, or any combination thereof, may be used to make such a mixture. More specifically, with regard to vitamin B1 (thiamine), it is used in many different areas of metabolism in the body (such as in carbohydrate metabolism). Thiamine also helps enhance circulation, is utilized for blood formation, is required for a healthy nervous system, and is used in the biosynthesis of neurotransmitters such as acetylcholine and GABA. It is also necessary for hydrochloric acid production, and thus plays a role in digestion.

Minor deficiencies in thiamine can cause symptoms such as fatigue, irritability, forgetfulness, and loss of appetite. Thiamine is particularly important to patients with diabetes who are prone to heart problems, neuropathy, and also kidney problems. Toxicity of thiamine is very rare. However, since thiamine is a water-soluble vitamin, what the body cannot use is excreted in the urine. It has been shown that patients with diabetes expelled thiamine at fifteen times the normal rate. This shows the need for more thiamine in patients with diabetes, and may account for the nerve problems and fatigue seen in many patients with diabetes. Thiamine is also destroyed in the process of cooking, and is not found to a great extent in processed foods. This provides further evidence that thiamine is an important supplement for overall good health.

With regard to vitamin B5, it is a vitamin found in numerous cellular reactions in the body that is involved in the breakdown of fat and protein, helps make red blood cells, sex hormones, and adrenal hormones and is used in the manufacture of a neurotransmitter acetylcholine. In addition, vitamin B5 makes vitamin B2 made more effective. Vitamin B5 is also part of an enzyme that helps with fat burning (co-enzyme A). Other important functions of vitamin B5 include its involvement in the manufacturing of melatonin in the body, which is responsible for a good sleep cycle, and its involvement in regulating hormones in the adrenal cortex, which are activated when the body is under stress. Thus, vitamin B5 may be characterized as an “anti-stress” vitamin. Finally, vitamin B5 has been shown to help correct dyslipidemia, keeping lipids lower, which is of consequence to patients with diabetes, because such patients have a greater risk for heart disease, and high levels of lipids are known to present a serious risk factor for heart disease.

With regard to vitamin B6, it is a supplement that is involved in a significant number of vital bodily functions. For example, B6 is a co-enzyme involved in the metabolism of protein and carbohydrates, and aids in the formation of blood cells. Vitamin B6 is also involved in the synthesis of neurotransmitters and prostaglandins and is necessary for proper B12 absorption. In addition, vitamin B6 helps to control stress because it is used in the synthesis of essential neurotransmitters. Stress control is important for persons suffering from diabetes because stress is known to make blood glucose control more difficult.

There appears to be an inverse relationship of vitamin B6 and homocysteine. This is important because homocysteine is a known risk factor in heart disease, and patients with diabetes have a significant increased risk for heart disease. Peripheral neuropathy, which affects many patients with diabetes, is a known result of pyridoxine deficiency in some cases.

The two major forms of vitamin B6 are pyridoxine and pyridoxamine They are converted in the liver to a co-factor, pyridoxy-5-phosphate (PCP) that is a main component of the essential metabolic functions of vitamin B6. PCP is utilized to help with the conversion of glycogen to glucose in the liver, and helping to inhibit platelet aggregation.

With regard to biotin (vitamin B7), it is one of the more recently discovered water-soluble B vitamins and is essential for the activity of many enzyme systems, and plays a strong role in the production of energy from the metabolism of carbohydrates and fats. Biotin is believed to stimulate liver glucokinase activity, increasing insulin production, and enhancing glucose uptake in muscle cells. It has been also shown that in patients with diabetes, there is an inverse relationship between blood sugars and biotin. As blood sugar levels rise, levels of biotin fall, and vice versa.

With regard to folic acid (vitamin B9), it is essential for the synthesis of adenine and thymine, two of the four nucleic acids that make up our genetic material. In addition, folic acid is also required for the proper metabolism of methionine, which is an amino acid found primarily in animal proteins. Thus, folic acid plays an important role because in this metabolic process it prevents the buildup of homocysteine, which may be a strong risk factor for coronary heart disease. Indeed, it has been shown that high homocysteine levels not only increase the risk of coronary heart disease, but also raise the risk of heart attack, strokes, and peripheral vascular disease. As stated above, diabetes is an independent risk factor for heart disease, and diabetic patients have a greater risk for heart disease. Folic acid may be also beneficial as a potential treatment of depression and kidney disease, both conditions being typical concomitants of diabetes.

With regard to niacinamide, it shares certain structural similarities with niacin, but behaves somewhat differently in the body. It is a co-enzyme involved in tissue respiration, lipid metabolism, and glycogenolysis. Unlike niacin, it does not cause flushing. There have been studies showing that niacinamide may protect islet cells from destruction, thereby possibly preventing diabetes. This is based on the fact that in part diabetes can be caused by an autoimmune reaction where the body starts destroying islet cells, which can contribute to the cause of diabetes. Niacinamide may prevent such islet cell destruction.

The total content of a vitamin of the group B vitamins or a mixture of several group B vitamins in the powder composition can be between about 0.01 mass % and about 6.0 mass % of the entire powder composition, for example, about 4.0 mass %. In one exemplary embodiment where all of vitamins B1, B5, B6, biotin, niacinamide, and/or B9 are used to prepare the powder composition, their content in the powder composition can be as follows: for vitamin B1, between about 0.1 mass % and about 0.5 mass %, for example, about 0.3 mass % of the entire powder composition; for vitamin B5, between about 1.0 mass % and about 5.0 mass %, for example, about 2.5 mass % of the entire powder composition; for vitamin B6, between about 0.2 mass % and about 1.5 mass %, for example, about 0.8 mass % of the entire powder composition; for biotin, between about 0.01 mass % and about 0.5 mass %, for example, about 0.1 mass % of the entire powder composition; for vitamin B9, between about 0.01 mass % and about 0.5 mass %, for example, about 0.1 mass % of the entire powder composition; and for niacinamide, between about 0.1 mass % and about 1.0 mass %, for example, about 0.4 mass % of the entire powder composition.

As mentioned in the above embodiments, the powder composition further comprises chromium picolinate. Chromium is known to be an essential trace mineral facilitating the metabolic processes; for example, chromium works with insulin to shuttle blood sugar into body and brain cells before it can be converted into fat. This mineral also helps mitochondria turn sugar into energy. The total content of chromium picolinate in the powder composition can be between about 0.01 mass % and about 0.08 mass % of the entire powder composition, for example, about 0.04 mass %.

As also mentioned above, the powder composition further comprises calcium carbonate, although other calcium salts may be used with varying efficiency. Calcium has been shown to be essential for normal function of the heart, nerves, and muscles. It is involved in blood coagulation (in which connection it is called coagulation factor IV). Calcium carbonate also adds to the effervescence of certain formulas, which can increase the bio-availability. Cell permeability has been shown to be inversely proportional to the presence of calcium, and there is some evidence that calcium carbonate escorts vitamins and nutrients through the cell wall more readily. The total content of calcium carbonate in the powder composition can be between about 10.0 mass % and about 15.0 mass % of the entire powder composition, for example, about 13.0 mass %.

Optionally, the powder composition may further include other vitamins, such as vitamins A, C, or E, or any combination thereof, if desired. With regard to vitamin A, it is known to be is necessary for bone growth, testicular function, ovarian function, embryonic development, and differentiation of tissues. Vitamin A also offers benefits for eye health by protecting against the effects of aging. In the pigment epithelial tissues of the retina, vitamin A compounds bind to opsin proteins in the rods and cones; which produce the photosensitive proteins that allow us to see better at night. Aging and diabetes both cause increased free radical damage and a gradual decline in circulation and oxygenation of tissues. It is well established that various eyesight problems such as cataracts, retinopathy, macular degeneration, and night blindness are more prevalent in patients with diabetes. Diabetic retinopathy is a common cause of blindness and in the U.S. it is the leading cause of new blindness in those of occupational age. Accordingly, anti-oxidants like vitamin A are recommended to improve eye health for patients with diabetes.

With regard to vitamin C, it is a water-soluble vitamin that is required for the synthesis of the body's stress hormones in the adrenal glands, including epinephrine, norepinephrine, cortisol, and histamine. Fever, burns, exposure to cold, and physical trauma all require larger doses of this vitamin. Like vitamin A, vitamin C is an anti-oxidant, and is, therefore, helpful, as diabetes is known to cause the body to make several oxidative by-products, leading to the complications of diabetes. Vitamin C is also used in the production of neurotransmitters that are essential in avoiding depression.

In addition, many patients with diabetes have trouble with wound healing and vitamin C should be of benefit to them because it forms collagen and helps repair tissue. Also, it has been shown that people with diabetes have about 30% lower plasma levels of vitamin C than people who do not. Vitamin C has been shown to reduce the activity of the enzyme aldose reductase, which is responsible for complications from this diabetes because this enzyme promotes the accumulation of sorbitol in the eyes, nerves, and kidneys of people with diabetes. Accordingly, patients with diabetes have a greater need for vitamin C.

With regard to vitamin E, it is a major fat-soluble anti-oxidant that can pass through human membranes and enter cells. Fat-soluble anti-oxidants protect fatty tissues from spoiling or turning rancid, via the process of lipid peroxidation. This “free radical damage” may contribute to diabetes by either impairing insulin secretion or increasing insulin resistance. For diabetic patients vitamin E is also believed to substantially reduce the risk of dying from heart disease.

If vitamins A, C, and/or E are used, their content in the powder composition can be: for vitamin A, between about 0.01 mass % and about 0.05 mass %, for example, about 0.03 mass % of the entire powder composition; for vitamin C, between about 9.0 mass % and about 14.0 mass %, for example, about 11.0 mass % of the entire powder composition; and for vitamin E, between about 2.0 mass % and about 5.0 mass %, for example, about 3.0 mass % of the entire powder composition.

Optionally, the powder composition may further include other components, such as additives, effervescent agents, colorants, anti-oxidants and the like, if desired. Non-limiting examples of such additional ingredients include riboflavin, cyanocobalamin, potassium bicarbonate, sodium bicarbonate, citric acid, natural flavors, dicalcium phosphate, magnesium oxide, sucralose, and β-carotene. Those having ordinary skill in the art will be able to determine, without undue experimentation, if any such additives are necessary, and if so, to select the most proper amount of each additive.

Any composition satisfying the above-described requirements can be prepared using common formulating techniques known to those having ordinary skill in the art. For example, the above-described components can be mixed together using known mixing techniques and equipment, for example, using a drum mixer, a screw mixer, or a ball mill, and the like. Alternatively, each component, in a separate container, can be preliminarily dissolved in water, or otherwise mixed with water resulting in a plurality of water-based systems, each contained in a separate container. The contents of all the containers can then be combined, e.g., by stirring or shaking, to form the combined solution, followed by removing water, e.g., by evaporating at atmospheric or reduced pressure or by freeze drying. Those having ordinary skill in the art will select the most appropriate method of preparing the powder composition.

If desired, those having ordinary skill in the art can design other methods of mixing the components forming the composition. Regardless of the method of mixing that is selected, those having ordinary skill in the art will provide such quantities of each component so that the concentration of each of the components in the composition satisfies the above-described limits. The final powder composition is comprised of fine spherical, oval, oblong, or irregularly-shaped solid particles having the median size of between about 0.05 microns and about 2.0 microns, such as about 1.0 micron.

In many of the above embodiments, to prepare an energy beverage, the above described powder composition is dissolved in water. For example, an individual 4.5 gram serving of the powder composition may be dissolved in 9-12 ounces of water to make a beverage, which can be drunk by a person suffering from diabetes.

The following examples are provided to further illustrate the advantages and features of the present invention, but are not intended to limit the scope of the invention.

### EXAMPLE 1

### Preparation and Use of Powder Composition #1

Powder composition # 1 can be prepared by energetic mixing the following components, in the quantities shown in Table 1:

TABLE 1
Ingredients for Making Composition # 1

| Component | Quantity | Units |
|---|---|---|
| Vitamin A Palmitate (Type 250 IU) | 500 | IU⁽*⁾ |
| Thiamin Mononitrate | 1.5 | mg |
| Riboflavin (Pure Powder) | 3.4 | mg |
| Calcium -D Pantothenate | 12.5 | mg |
| Pyridoxine HCl USP | 4 | mg |
| Folic Acid (100%) | 0.5 | mg |
| Cyanocobalamin (100% Crystals) | 0.01 | mg |
| Ascorbic Acid (Vitamin C) | 60 | mg |
| Dry Vitamin E (50% CWS/S 500 IU acetate) | 15 | mg |
| D-Biotin (100% Pure) | 0.5 | mg |
| Calcium (as calcium carbonate) | 70 | mg |
| Chromium Picolinate | 0.2 | mg |
| Niacinamide (Fine Powder) | 20 | mg |
| Potassium (as potassium bicarbonate) | 200 | mg |
| Sodium (as sodium bicarbonate USP #1 FMC) | 140 | mg |

⁽*⁾International Units (1 IU of vitamin A corresponds to ~0.3 μg)

The resulting composition # 1 can be then dissolved in about 9 to 12 oz of pure water to make a beverage, which can then be orally consumed by a person suffering from diabetes.

Although the embodiments of the inventive subject matter have been described with reference to the above examples, it will be understood that modifications and variations are encompassed within the spirit and scope of the inventive subject matter. Accordingly, the subject matter disclosed is limited only by the following claims.

What is claimed is:

1. A powder composition for preparing an energy beverage, the powder composition comprising:
(a) a quantity of at least one vitamin selected from the group B vitamins;
(b) a quantity of chromium picolinate; and
(c) a quantity of calcium carbonate,
wherein the powder composition consists essentially of solid particles having the median size of between about 0.05 microns and about 2.0 microns.

2. The powder composition of claim 1, with the further proviso that the composition is free of caffeine, free of sugar and free of herbal ingredients capable of stimulating the adrenal glands or cause changes to the vaso-dilation system.

3. The powder composition of claim 1, wherein the vitamin is selected from the group consisting of vitamin B1, vitamin B5, vitamin B6, biotin, niacinamide, and vitamin B9.

4. The powder composition of claim 3, wherein the concentration of vitamin B1 in the powder composition is between about 0.1 mass % and about 0.5 mass %.

5. The powder composition of claim 3, wherein the concentration of vitamin B5 in the powder composition is between about 1.0 mass % and about 5.0 mass %.

6. The powder composition of claim 3, wherein the concentration of vitamin B6 in the powder composition is between about 0.2 mass % and about 1.5 mass %.

7. The powder composition of claim 3, wherein the concentration of biotin in the powder composition is between about 0.01 mass % and about 0.5 mass %.

8. The powder composition of claim 3, wherein the concentration of niacinamide in the powder composition is between about 0.1 mass % and about 1.0 mass %.

9. The powder composition of claim 3, wherein the concentration of vitamin B9 in the powder composition is between about 0.01 mass % and about 0.5 mass %.

10. The powder composition of claim 1, wherein total content of the group B vitamin or a mixture of several group B vitamins in the powder composition is between about 0.01 mass % and about 6.0 mass %.

11. The powder composition of claim 1, further comprising a quantity of at least one vitamin selected from the group consisting of vitamin A, vitamin C, and vitamin E

12. An energy beverage, comprising the powder composition of claim 1, and a quantity of water.

13. The energy beverage of claim 12, wherein the concentration of the powder composition in the energy beverage is between about 56 mass % and about 83 mass %.

14. A kit comprising a packaging material and the powder composition of claim 1 contained within the packaging material, wherein the packaging material comprises a label which indicates that the powder composition can be used for preparing an energy beverage suitable for oral consumption by a person suffering from diabetes.

15. A method for providing additional energy to a person suffering from diabetes, the method comprising:
(a) preparing the energy beverage of claim 12; and
(b) orally consuming the energy beverage by the person suffering from diabetes and in need of additional energy,
thereby providing additional energy to the person suffering from diabetes.
